(19) United States
(12) Patent Application Publication
(10) Pub. No.: US 2010/0061432 A1
(43) Pub. Date: Mar. 11, 2010

(54) REDUCED COST SAW-LESS CATV RF TUNER CIRCUIT FOR USE IN A CABLE MODEM

(75) Inventors: Oren Ben-Hamo, Rehovot (IL); Boris Froimovich, Netanya (IL); Moshe Meir, Rehovot (IL); Ronen Ezra, Kfar Seba (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/208,457

(22) Filed: Sep. 11, 2008

(51) Int. Cl. H04B 1/38; H04B 3/00

(52) U.S. Cl. 375/222; 375/257

(57) ABSTRACT

A novel reduced cost CATV RF tuner circuit that can serve as a replacement circuit for one based on a surface acoustic wave (SAW) filter. The tuner circuit is particularly suitable for use in cable modem systems adapted to implement the DOCSIS 2.0 specification which specifies single channel video reception. The invention replaces the traditional SAW filter functions of image rejection and channel selection with both analog and digital components and circuits. The image rejection function is performed by a combination of analog multiple filters. Digital filtering is then used to perform the channel selection operation. The analog based image reject filter can be constructed using relatively inexpensive passive components, while the digital channel selection filter can be implemented in software, firmware, gate array (FPGA) or ASIC.

### FIELD OF THE INVENTION

The present invention relates to the field of data communications and more particularly relates to a reduced cost CATV RF tuner circuit incorporating an analog image reject filter that eliminates the need for the use of a surface acoustic wave (SAW) device in the tuner circuit of a cable modem such as a Data Over Cable Service Interface Specification (DOCSIS) compliant cable modem.

### BACKGROUND OF THE INVENTION

Currently there are more than 50 million high-speed Internet access customers in North America. Recently, the cable modem has become the broadband connection of choice for many Internet users, being preferred over the nearest rival broadband technology, Digital Subscriber Line (DSL), by a significant margin.

Cable modems are well known in the art. A cable modem is a type of modem that provides access to a data signal sent over the cable television (CATV) infrastructure. Cable modems are primarily used to deliver broadband Internet access, taking advantage of unused bandwidth on a cable television network. In 2005 there were over 22.5 million cable modem users in the United States alone.

A cable modem is a network appliance that enables high speed data connections to the internet via data services provided by the local cable company. Data from the home is sent upstream on a carrier that operates on the 5 MHz to 42 MHz band of the cable spectrum. Downstream data is carried on a 88 MHz to 860 MHz band. The cable modem system can have additional networking features such as Voice over IP (VoIP), wireless connectivity or network switch or hub functionality.

The term cable Internet access refers to the delivery of Internet service over the cable television infrastructure. The proliferation of cable modems, along with DSL technology, has enabled broadband Internet access in many countries. The bandwidth of cable modem service typically ranges from 3 Mbps up to 40 Mbps or more. The upstream bandwidth on residential cable modem service usually ranges from 384 kbps to 30 Mbps or more. In comparison, DSL tends to offer less speed and more variance between service packages and prices. Service quality is also far more dependent on the client's location in relation to the telephone company's nearest central office or Remote Terminal.

Users in a neighborhood share the available bandwidth provided by a single coaxial cable line. Therefore, connection speed varies depending on how many people are using the service at the same time. In most areas this has been eliminated due to redundancy and fiber networks.

With the advent of Voice over IP telephony, cable modems are also being used to provide telephone service. Many people who have cable modems have opted to eliminate their Plain Old Telephone Service (POTS). An alternative to cable modems is the Embedded Multimedia Terminal Adapter (EMTA). An EMTA allows multiple service operators (MSOs) to offer both High Speed Internet and VoIP through a single piece of customer premise equipment. A multiple system operator is an operator of multiple cable television systems.

Many cable companies have launched Voice over Internet Protocol (VoIP) phone service, or digital phone service, providing consumers a true alternative to standard telephone service. Digital phone service takes the analog audio signals and converts them to digital data that can be transmitted over the fiber optic network of the cable company. Cable digital phone service is currently available to the majority of U.S. homes with a large number of homes are now subscribing. The number of homes subscribing is currently growing by hundreds of thousands each quarter. One significant benefit of digital phone service is the substantial consumer savings, with one recent study saying residential cable telephone consumers could save an average of $135 or more each year.

The Data Over Cable Service Interface Specification (DOCSIS) compliant cable modems have been fueling the transition of cable television operators from a traditional core business of entertainment programming to a position as full-service providers of video, voice, and data telecommunications services.

Cable systems transmit digital data signals over radio frequency (RF) carrier signals. To provide two-way communication, one carrier signal carries data in the downstream direction from the cable network to the customer and another carrier signal carries data in the upstream direction from the customer to the cable network. Cable modems are devices located at the subscriber premises that functions to convert digital information into a modulated RF signal in the upstream direction, and to convert the RF signals to digital information in the downstream direction. A cable modem termination system (CMTS) performs the opposite operation for multiple subscribers at the cable operator's head-end.

Typically, several hundreds of users share a 6 MHz downstream channel and one or more upstream channels. The downstream channel occupies the space of a single television transmission channel in the cable operator's channel lineup. It is compatible with digital set top MPEG transport stream modulation (64 or 256 QAM), and provides up to 40 Mbps. A media access control (MAC) layer coordinates shared access to the upstream bandwidth.

SAW filters are electromechanical devices commonly used in RF applications. In a SAW filter, electrical signals are converted to a mechanical wave in a piezoelectric crystal; this wave is delayed as it propagates across the crystal, before being converted back to an electrical signal by further electrodes. The delayed outputs are recombined to produce a direct analog implementation of a finite impulse response (FIR) filter.

Traditionally, the tuner circuits employ surface acoustic wave (SAW) filters to provide both (1) image rejection generated mixing operations and (2) channel selection functionality. In applications, such as DOCSIS 2.0, it is necessary to remove adjacent channels and output the selected channel based on a tune command, such as derived from user input.

SAW filters, however, are relatively expensive components and it is desirable to have an alternative solution to reduce the bill of material (BOM) cost of products incorporating these devices, such as cable modems. Any alternative solution should meet the requirements of the DOCSIS cable modem specification, operate efficiently, exhibit high performance, consume minimal board and chip area and be able to be manufactured at low cost.

### SUMMARY OF THE INVENTION

The present invention is a novel reduced cost CATV RF tuner circuit that can serve as a replacement circuit for one based on a surface acoustic wave (SAW) filter. The tuner circuit is particularly suitable for use in cable modem systems adapted to implement the DOCSIS 2.0 specification which specifies single channel video reception.

The invention replaces the traditional SAW filter functions of image rejection and channel selection with both analog and digital components and circuits. The image rejection function is performed by a combination of analog multiple filters. Digital filtering is then used to perform the channel selection operation. The analog based image reject filter can be constructed using relatively inexpensive passive components, while the digital channel selection filter can be implemented in software, firmware, gate array (FPGA) or ASIC.

The invention is applicable to implementation in systems other than cable modems. In particular, it is applicable in numerous receiver or tuner circuit designs that currently employ SAW filters. In these systems, the SAW filter can be replaced with the combination analog based image reject filter and digital based channel selection filter, or either one alone. In either case, use of the circuits and techniques of the present invention provide significant cost reductions over the SAW based circuits of the prior art.

To aid in understanding the principles of the present invention, the description is provided in the context of a DOCSIS 2.0 capable cable system comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any receiver/tuner that employs a SAW filter and would benefit from a reduction in BOM cost.

Several advantages of the reduced cost CATV RF tuner circuit of the present invention include (1) adequate performance to meet DOCSIS specifications; and (2) significant reduction in cost compared to SAW based designs.

Note that many aspects of the invention described herein may be constructed as software objects that are executed in embedded devices as firmware, software objects that are executed as part of a software application on either an embedded or non-embedded computer system running a real-time operating system such as WinCE, Symbian, OSE, Embedded LINUX, etc. or non-real time operating system such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a surface acoustic wave (SAW) replacement circuit comprising an image reject filter operative to remove aliasing from a multi-channel signal input thereto and a digital filter operative to output selected one or more channels from the output of the image reject filter.

There is also provided in accordance with the invention, an image reject filter for use in a cable modem comprising a band pass filter coupled to an intermediate frequency (IF) signal input and having a first filter response, a buffer coupled to the output of the band pass filter, a low pass filter coupled to the output of the buffer and having a second filter response, the low pass filter operative to generate a filtered output signal therefrom and wherein the first filter response combined with the second filter response yields a combined response operative to remove aliasing in the IF input signal produced during one or more previous mixing stages.

There is further provided in accordance with the invention, a receive signal path for use in a Data Over Cable Service Interface Specification (DOCSIS) compatible cable modem comprising a tuner integrated circuit (IC) operative to generate an intermediate frequency (IF) signal output in accordance with an RF input signal and a channel reference signal, an image reject filter coupled to the IF signal output and operative to remove aliasing therefrom and to generate a filtered IF signal thereby and a PHY circuit comprising a digital channel selection filter coupled to the filtered IF signal and operative to output one of a plurality of channels in accordance with a corresponding tune command.

There is also provided in accordance with the invention, a cable modem comprising a memory, one or more interface ports, a single chip tuner integrated circuit (IC), the tuner IC comprising a frequency reference input, means for generating a channel reference signal from the frequency reference input in accordance with a tune command signal, a CATV radio frequency (RF) receive signal input, a tuner circuit operative to mix the RF receive signal with the channel reference signal to yield an intermediate frequency (IF) signal thereby, an off-chip image reject filter coupled to the IF signal and operative to remove aliasing therefrom and to generate a filtered IF signal thereby, a PHY circuit coupled to the tuner, the PHY circuit comprising a digital channel selection filter coupled to the filtered IF signal and operative to output one of a plurality of raw video channel streams in accordance with a corresponding tune command and a processor coupled to the memory, the one or more interface ports, the tuner and the PHY circuit, the processor operative to implement a media access control (MAC) layer operative to generate one or more output video streams from the plurality of raw video streams input thereto.

### BRIEF DESCRIPTION OF THE DRAWINGS

The invention is herein described, by way of example only, with reference to the accompanying drawings, wherein:

FIG. 1 is a block diagram illustrating an example cable modem system incorporating the downstream system of the present invention;

FIG. 2 is a block diagram illustrating an example cable modem containing an RF tuner incorporating the SAW-less CATV RF tuner circuit of the present invention for single channel video reception;

FIG. 3 is a simplified block diagram illustrating the processor of the cable modem of FIG. 2 and its connection to the SAW-less CATV RF tuner circuit of the present invention in more detail;

FIG. 4 is a frequency spectrum diagram illustrating the ADC input spectrum showing the location of image signals in the frequency domain;

FIG. 5 is a block diagram illustrating the downstream path including the SAW-less CATV RF tuner circuit of the present invention in more detail;

FIG. 6 is a block diagram illustrating an example SAW-less CATV RF tuner circuit of the cable modem of the present invention;

FIG. 7 is a schematic diagram illustrating an example implementation of the band pass filter portion of the analog image reject filter of the present invention;

FIG. 8 is a graph illustrating the frequency response and return loss of the band pass filter of FIG. 7;

FIG. 9 is a schematic diagram illustrating an example implementation of the low pass filter portion of the analog image reject filter of the present invention;

FIG. 10 is a graph illustrating the frequency response and return loss of the low pass filter of FIG. 7;

FIG. 11 is a graph illustrating the overall frequency response of the combined band pass and low pass filters making up the image reject filter;

FIG. 12 is a graph illustrating the group delay of the band pass filter portion of the image reject filter;

FIG. 13 is a graph illustrating the group delay of the low pass filter portion of the image reject filter; and

FIG. 14 is a graph illustrating a Monte Carlo analysis of the image reject filter including both band pass and low pass filters.

### DETAILED DESCRIPTION OF THE INVENTION

### Notation Used Throughout

The following notation is used throughout this document.

| Term | Definition |
|---|---|
| AC | Alternating Current |
| ADC | Analog to Digital Converter |
| ASIC | Application Specific Integrated Circuit |
| BPF | Bandpass filter |
| CATV | Community Antenna Television or Cable TV |
| CBW | Capture Bandwidth |
| CM | Cable Modem |
| CMOS | Complementary Metal Oxide Semiconductor |
| CMTS | Cable Modem Termination System |
| CO | Central Office |
| CPU | Central Processing Unit |
| DAC | Digital to Analog Converter |
| DC | Direct Current |
| DCAS | Downloadable Conditional Access Systems |
| DCXO | Digitally Controlled Crystal Oscillator |
| DECT | Digital Enhanced Cordless Telecommunications |
| DHCP | Dynamic Host Control Protocol |
| DOCSIS | Data Over Cable Service Interface Specification |
| DS | Downstream |
| DSL | Digital Subscriber Line |
| DSP | Digital Signal Processor |
| DVR | Digital Video Recorder |
| EEROM | Electrically Erasable Read Only Memory |
| EMTA | Embedded Multimedia Terminal Adapter |
| FPGA | Field Programmable Gate Array |
| GPIO | General Purpose I/O |
| HDL | Hardware Description Language |
| I/F | Interface |
| I/O | Input/Output |
| I²C | Inter-Integrated Circuit bus |
| IC | Integrated Circuit |
| IP | Internet Protocol |
| LAN | Local Area Network |
| LED | Light Emitting Diode |
| LNA | Low Noise Amplifier |
| LPF | Low Pass Filter |
| MAC | Media Access Control |
| MPEG | Moving Picture Experts Group |
| MSO | Multiple Service Operator |
| NB | Narrowband |
| PC | Personal Computer |
| PCB | Printed Circuit Board |
| PDA | Personal Digital Assistant |
| PGA | Programmable Gain Amplifier |
| PLL | Phase Locked Loop |
| POTS | Plain Old Telephone Service |
| PSTN | Public Switched Telephone Network |
| QAM | Quadrature Amplitude Modulation |
| QoS | Quality of Service |
| RAM | Random Access Memory |
| RF | Radio Frequency |
| ROM | Read Only Memory |
| SLIC | Subscriber Line Interface Card |
| SONET | Synchronous Optical Network |
| TB | Tuning Band |
| US | Upstream |
| USB | Universal Serial Bus |
| VCO | Voltage Controlled Oscillator |
| VGA | Variable Gain Amplifier |
| VoIP | Voice over IP |
| WAN | Wide Area Network |
| WB | Wideband |
| WLAN | Wireless Local Area Network |
| XO | Crystal Oscillator |

### Detailed Description of the Invention

The present invention is a novel reduced cost CATV RF tuner circuit that can serve as a replacement circuit for one based on a surface acoustic wave (SAW) filter. The tuner circuit is particularly suitable for use in cable modem systems adapted to implement the DOCSIS 2.0 specification which specifies single channel video reception.

The invention replaces the traditional SAW filter functions of image rejection and channel selection with both analog and digital components and circuits. The image rejection function is performed by a combination of analog multiple filters. Digital filtering is then used to perform the channel selection operation. The analog based image reject filter can be constructed using relatively inexpensive passive components, while the digital channel selection filter can be implemented in software, firmware, gate array (FPGA) or ASIC.

To aid in understanding the principles of the present invention, the description is provided in the context of a DOCSIS 2.0 capable cable system comprising a cable modem adapted to receive an DOCSIS compatible RF signal feed from a cable head-end (i.e. CMTS) and to distribute video, Internet and telephony to a subscriber premises. It is appreciated, however, that the invention is not limited to use with any particular communication device or standard and may be used in optical, wired and wireless applications. Further, the invention is not limited to use with a specific technology but is applicable to any situation which can benefit from a multi-tuner integrated circuit chip.

It is noted that the reduced cost CATV RF tuner circuit of the invention can be used in cable modems designed for use not only in North America, but also for use with the Euro DOCSIS standard using the same configuration.

Note that throughout this document, the term communications device is defined as any apparatus or mechanism adapted to transmit, or transmit and receive data through a medium. The communications device may be adapted to communicate over any suitable medium such as RF, wireless, infrared, optical, wired, microwave, etc. In the case of wireless communications, the communications device may comprise an RF transmitter, RF receiver, RF transceiver or any combination thereof.

The term cable modem is defined as a modem that provides access to a data signal sent over the cable television infrastructure. The term voice cable modem is defined as a cable modem that incorporates VoIP capabilities to provide telephone services to subscribers

### Cable System Incorporating SAW-Less CATV RF Tuner

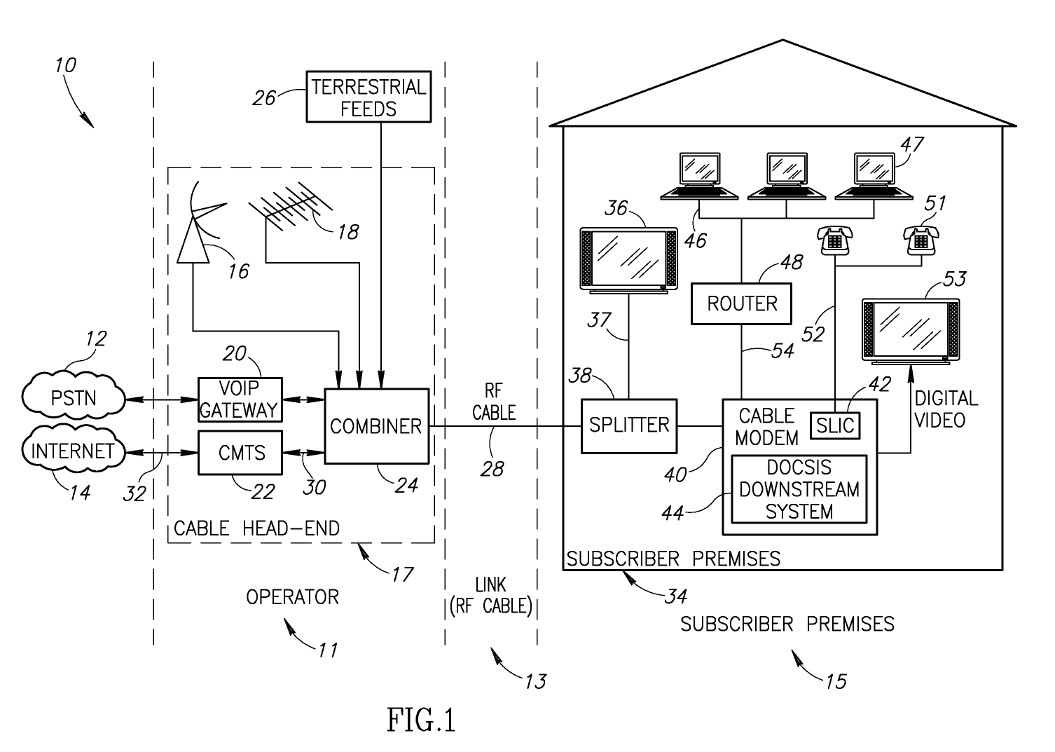

A block diagram illustrating a cable modem system incorporating the downstream system of the present invention is shown in FIG. 1. The system, generally referenced 10, comprises an operator portion 11 connected to the public switched telephone network (PSTN) 12 and the Internet 14 or other wide area network (WAN), a link portion 13 comprising the RF cable 28 and a subscriber portion 15 comprising the subscriber premises 34.

The operator portion 11 comprises the cable head-end 17 which is adapted to receive a number of content feeds such as satellite 16, local antenna 18 and terrestrial feeds 26, all of which are input to the combiner 24. The cable head-end also comprises the voice over IP (VoIP) gateway 20 and Cable Modem Termination System (CMTS) 22. The combiner merges the TV programming feeds with the RF data from the CMTS.

The Cable Modem Termination System (CMTS) is a computerized device that enables cable modems to send and receive packets over the Internet. The IP packets are typically sent over Layer 2 and may comprise, for example, Ethernet or SONET frames or ATM cell. It inserts IP packets from the Internet into MPEG frames and transmits them to the cable modems in subscriber premises via an RF signal. It does the reverse process coming from the cable modems. A DOCSIS-compliant CMTS enables customer PCs to dynamically obtain IP addresses by acting as a proxy and forwarding DHCP requests to DHCP servers. A CMTS may provide filtering to protect against theft of service and denial of service attacks or against hackers trying to break into the cable operator's system. It may also provide traffic shaping to guarantee a specified quality of service (QoS) to selected customers. A CMTS may also provide bridging or routing capabilities.

The subscriber premises 34 comprises a splitter 38, cable appliances 36 such as televisions, DVRs, etc., cable modem 40, router 48, PCs or other networked computing devices 47 and telephone devices 51. Cable service is provided by the local cable provider wherein the cable signal originates at the cable head end facility 17 and is transmitted over RF cable 28 to the subscriber premises 34 where it enters splitter 38. One output of the splitter goes to the televisions, set top boxes, and other cable appliances via internal cable wiring 37.

The other output of the splitter comprises the data portion of the signal which is input to the cable modem 40. The cable modem is adapted to provide both Ethernet and USB ports. Typically, a router 48 is connected to the Ethernet port via Ethernet cable 54. One or more network capable computing devices 47, e.g., laptops, PDAs, desktops, etc. are connected to the router 48 via internal Ethernet network wiring 46. In addition, the router may comprise or be connected to a wireless access point that provides a wireless network (e.g., 802.11b/g/a) throughout the subscriber premises.

The cable modem also comprises a subscriber line interface card (SLIC) 42 which provides the call signaling and functions of a conventional local loop to the plurality of installed telephone devices 51 via internal 2-wire telephone wiring 52. In particular, it generates call progress tones including dial tone, ring tone, busy signals, etc. that are normally provided by the local loop from the CO. Since the telephone deices 51 are not connected to the CO, the SLIC in the cable modem must provide these signals in order that the telephone devices operate correctly.

The cable modem also comprises a downstream system 44 which incorporates the SAW-less CATV RF tuner of the present invention. A digital video output signal is displayed to the user (i.e. cable subscribers) via television set 53 (i.e. video display device or other cable appliance). The tuner enables the reception of a single video channel without the use of a SAW filter, as described in more detail infra.

### DOCSIS 2.0 Channel Cable Modem

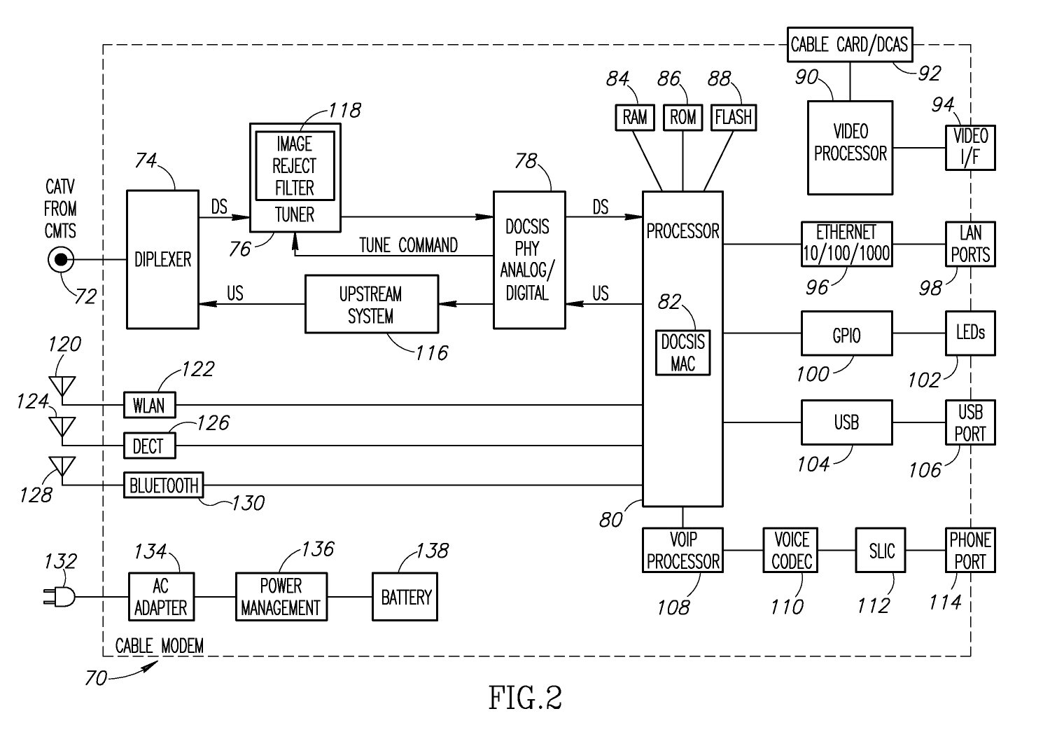

A block diagram illustrating an example cable modem incorporating the SAW-less CATV RF tuner circuit of the present invention is shown in FIG. 2. The cable modem, generally referenced 70, comprises a duplexer 74, SAW-less CATV RF tuner circuit 76 incorporating image reject filter 118, DOCSIS PHY (analog/digital) 78, DOCSIS compatible processor 80, DOCSIS MAC 82, VoIP processor 108, voice codec 110, subscriber line interface card (SLIC) 112, phone port 114, wireless local area network (WLAN) 122 and associated antenna 120, DECT 126 and associated antenna 124, Bluetooth 130 and associated antenna 128, Ethernet interface 96, Ethernet LAN ports 98, general purpose (I/O) (GPIO) interface 100, LEDs 102, universal serial bus (USB) interface 104, USB port 106, cable card/Downloadable Conditional Access Systems (DCAS) 92, video interface (I/F) 94, video processor 90, upstream system 116, AC adapter 134 coupled to mains utility power via plug 132, power management circuit 136, battery 138, RAM 84, ROM 86 and FLASH memory 88.

Note that in the example embodiment presented herein, the cable modem and DOCSIS enabled processor are adapted to implement the DOCSIS 2.0 standard which provides for multiple channel video reception. In addition, the SAW-less tuner circuit 79 may comprise a single tuner, quad tuner (comprises four tuner sub-circuits), etc. incorporating the image reject filter of the present invention. Tuner circuits having any number of tuner sub-circuits may be constructed using the principles of the present invention.

In operation, the cable modem processor is the core chip set which in the example presented herein comprises a central single integrated circuit (IC) with peripheral functions added. The voice over IP (VoIP) processor 108 implements a mechanism to provide phone service outside the standard telco channel. Chipset DSPs and codecs 96 add the functionality of POTS service for low rate voice data.

The cable modem also comprises a subscriber line interface card (SLIC) 112 which functions to provide the signals and functions of a conventional local loop to a plurality of telephone devices connected via the phone port 114 using internal 2-wire telephone wiring. In particular, it generates call progress tones including dial tone, ring tone, busy signals, etc. that are normally provided by the local loop from the CO. Since the telephone deices are not connected to the CO, the SLIC in the cable modem must provide these signals in order that the telephone devices operate correctly.

In a traditional analog telephone system, each telephone or other communication device (i.e. subscriber unit) is typically interconnected by a pair of wires (commonly referred to as tip and ring or together as subscriber lines, subscriber loop or phone lines) through equipment to a switch at a local telephone company office (central office or CO). At the CO, the tip and ring lines are interconnected to a SLIC which provides required functionality to the subscriber unit. The switches at the central offices are interconnected to provide a network of switches thereby providing communications between a local subscriber and a remote subscriber.

The SLIC is an essential part of the network interface provided to individual analog subscriber units. The functions provided by the SLIC include providing talk battery (between 5 VDC for on-hook and 48 VDC for off-hook), ring voltage (between 70-90 VAC at a frequency of 17-20 Hz), ring trip, off-hook detection, and call progress signals such as ringback, busy, and dial tone.

A SLIC passes call progress tones such as dial tone, busy tone, and ringback tone to the subscriber unit. For the convenience of the subscriber who is initiating the call, these tones normally provided by the central office give an indication of call status. When the calling subscriber lifts the handset or when the subscriber unit otherwise generates an off hook condition, the central office generates a dial tone and supplies it to the calling subscriber unit to indicate the availability of phone service. After the calling subscriber has dialed a phone number of the remote (i.e. answering) subscriber unit, the SLIC passes a ring back sound directed to the calling subscriber to indicate that the network is taking action to signal the remote subscriber, i.e. that the remote subscriber is being rung. Alternatively, if the network determines that the remote subscriber unit is engaged in another call (or is already off-hook), the network generates a busy tone directed to the calling subscriber unit.

The SLIC also acts to identify the status to, or interpret signals generated by, the analog subscriber unit. For example, the SLIC provides −48 volts on the ring line, and 0 volts on the tip line, to the subscriber unit. The analog subscriber unit provides an open circuit when in the on-hook state. In a loop start circuit, the analog subscriber unit goes off-hook by closing, or looping the tip and ring to form a complete electrical circuit. This off-hook condition is detected by the SLIC (whereupon a dial tone is provided to the subscriber). Most residential circuits are configured as loop start circuits.

Connectivity is provided by a standard 10/100/1000 Mbps Ethernet interface 96 and Ethernet LAN port 98, USB interface 104 and USB port 106 or with additional chip sets, such as wireless 802.11a/b/g via WLAN interface 122 coupled to antenna 120. In addition, a GPIO interface 100 provides an interface for LEDs 102, etc. The network connectivity functions may also include a router or Ethernet switch core. Note that the DOCSIS MAC 82 and PHY 78 may be integrated into the cable modem processor 80 or may be separate.

In the example embodiment presented herein, the tuner 76 is coupled to the CATV signal from the CMTS via port 72 and is operative to convert the RF signal received over the RF cable to an IF frequency in accordance with the four tune command signals received from the processor.

The cable modem 70 comprises a processor 80 which may comprise a digital signal processor (DSP), central processing unit (CPU), microcontroller, microprocessor, microcomputer, ASIC, FPGA core or any other suitable processing means. The cable modem also comprises static read only memory (ROM) 86, dynamic main memory 84 and FLASH memory 88 all in communication with the processor via a bus (not shown).

The magnetic or semiconductor based storage device 84 (i.e. RAM) is used for storing application programs and data. The cable modem comprises computer readable storage medium that may include any suitable memory means, including but not limited to, magnetic storage, optical storage, semiconductor volatile or non-volatile memory, biological memory devices, or any other memory storage device.

Any software required to implement the SAW-less CATV RF tuner circuit of the present invention is adapted to reside on a computer readable medium, such as a magnetic disk within a disk drive unit. Alternatively, the computer readable medium may comprise a floppy disk, removable hard disk, Flash memory, EEROM based memory, bubble memory storage, ROM storage, distribution media, intermediate storage media, execution memory of a computer, and any other medium or device capable of storing for later reading by a computer a computer program implementing the system and methods of this invention. The software adapted to implement the SAW-less CATV RF tuner circuit of the present invention may also reside, in whole or in part, in the static or dynamic main memories or in firmware within the processor of the computer system (i.e. within microcontroller, microprocessor or microcomputer internal memory).

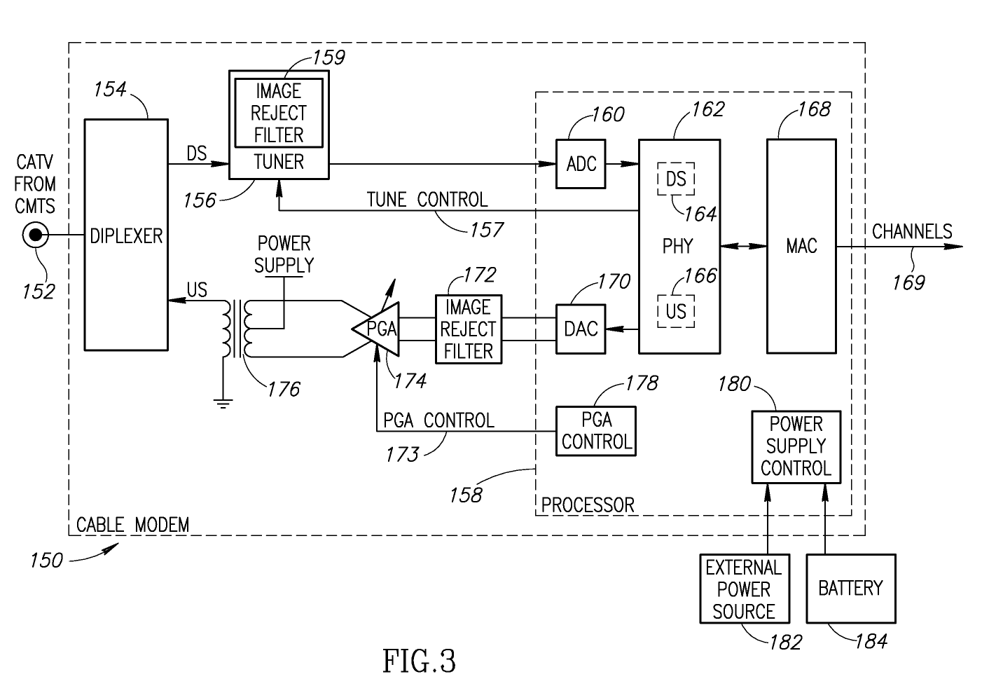

A simplified block diagram illustrating the processor of the cable modem of FIG. 2 and its connection to the SAW-less CATV RF tuner circuit of the present invention in more detail is shown in FIG. 3. The example cable modem, generally referenced 150, comprises diplexer 154 coupled to a CATV input 152, SAW-less CATV RF tuner circuit 156 incorporating image reject filter (downstream) 159, processor 158, image reject filter (upstream) 172, PGA 174 and balun 176. The processor 158 comprises an analog to digital converter (ADC) 160, PHY circuit 162, digital to analog converter (DAC) 170, PGA control circuit 178, power supply control 180 and MAC 168. Power is supplied by an external power source 182 e.g., utility power, etc. or a battery 184.

In operation, in the downstream (i.e. receive) direction, the receive signal from the diplexer is input to the SAW-less CATV RF tuner circuit 156. The tuner output signal is input to the ADC to provide I and Q input signals to the PHY circuit. The PHY circuit provides a tuner control signal 157 that controls the tuning of the tuner circuit. After MAC processing, one or more MPEG video streams 169 are output of the cable modem.

In the upstream (US) (i.e. transmit) direction, a digital TX output signal provided by the PHY circuit is converted to analog by the DAC. The analog signal is then filtered via the image reject filter 172 before being amplified by the PGA whose gain is controlled by a PGA control signal 173 generated by the PGA control circuit 178.

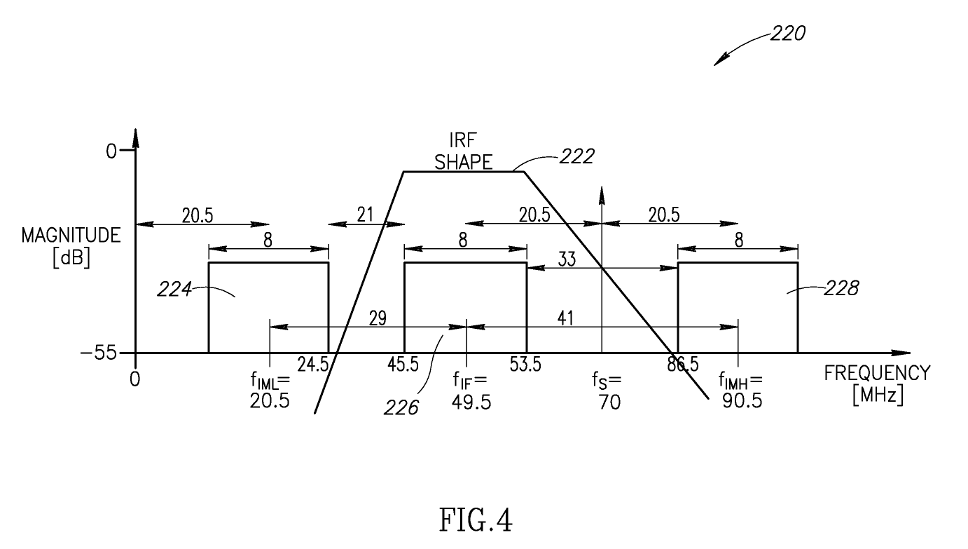

A graph illustrating the frequency spectrum of the aliasing channels and desired channel is shown in FIG. 4. The graph represents the spectrum of the ADC input in the PHY circuit (sampling frequency of 70 MHz), including the desired signal and its two closest digital aliasing. The requirements for the aliasing reject filter can be derived from this spectrum. The image reject filter (IRF) response 222 has a pass band of approximately 8 MHz 226 and is centered at an IF frequency of approximately 49.5 MHz. The lower image 224 has a bandwidth of 8 MHz, is centered at 20.5 MHz and has a closest aliasing at 24.5 MHz (i.e. −29 MHz from the center frequency of 49.5 MHz). The upper image 228 has a bandwidth of 8 MHz, is centered at 90.5 MHz and has a closest aliasing at 86.5 MHz (i.e. +49.5 MHz from the center frequency of 49.5 MHz). Example requirements (e.g., DOCSIS) for the IRF response are 55 dB rejection at the closest lower aliasing of 24.5 MHz and the closest upper aliasing of 86.5 MHz.

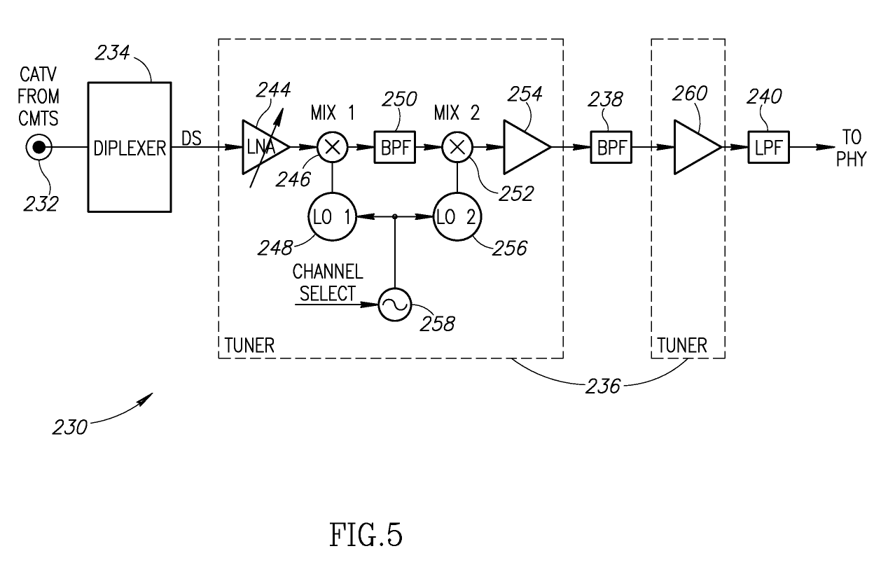

A block diagram illustrating the downstream path including the SAW-less CATV RF tuner circuit of the present invention in more detail is shown in FIG. 5. The circuit, generally referenced 230, comprises diplexer 234, tuner circuit 236, band pass filter (BPF) 238 and low pass filter (LPF) 240. The tuner circuit 230, which does not include a SAW filter, comprises adjustable LNA 244, frequency reference 258, mixer 1 246, local oscillator (LO) 248, BPF 250, mixer 2 252, LO 256 and amplifier/buffers 254, 260.

The CATV signal input 232 from the CMTS is input to the diplexer 234. The downstream signal (DS) output of the diplexer is amplified by LNA 244. Mixer 1 performs a first downconversion in accordance with LO 1 to a first IF. After being filtered by fixed image reject filter 250, the IF signal is downconverted to a second IF via mixer 2 in accordance with LO 2. The IF output is amplified 254 and filtered via an external (or alternatively internal) BPF 238 (external to the tuner circuit). The output of the BPF 238 is buffered (i.e. amplified) 260 and low pass filtered via an external (or alternatively internal) LPF 240 (external to the tuner circuit) before being output to the PHY circuit.

In accordance with the invention, the filter response of the BPF 238 and LPF 240 are combined to effectively remove aliasing generated by the previous mixing stage. The buffer 260 placed between the BPF and LPF is needed in order to combine the effects from both filters. Note that in alternative embodiments, a desired filter response can achieved by splitting the desired filter response over a plurality of filters whose effects can be combined to yield the desired filter response.

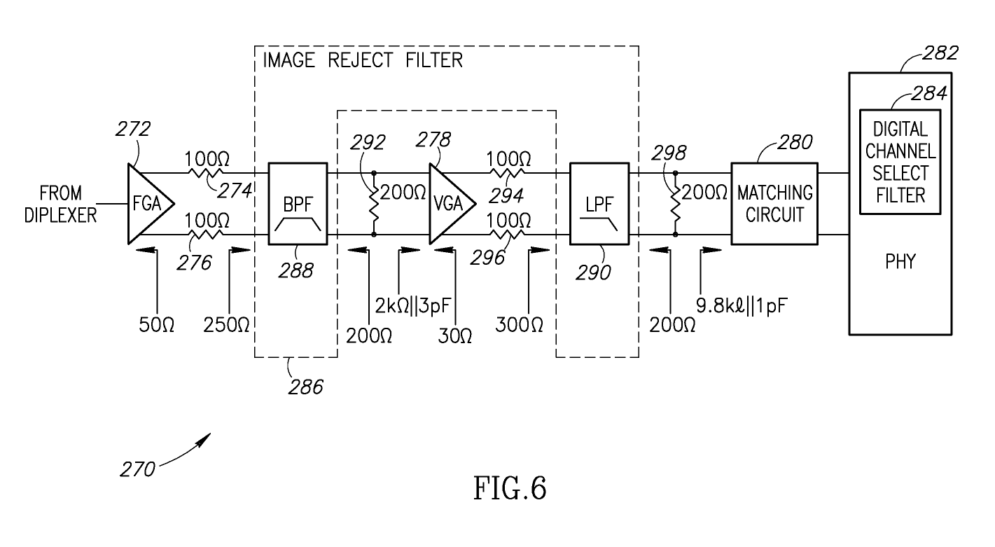

A block diagram illustrating an example SAW-less CATV RF tuner circuit of the cable modem of the present invention is shown in FIG. 6. The circuit, generally referenced 270, comprises a fixed gain amplifier (FGA) 272, analog image reject filter 286, variable gain amplifier (VGA)/buffer 278, resistors 274, 276, 292, 294, 296, 298, matching circuit 280 and PHY 282. The image reject image 286 comprises BPF 288 and LPF 290. The PHY circuit 282 comprises the digital channel select filter 284. Note that the tuner circuit is differential along with input to the PHY. The output/input impedances shown are differential.

In the example embodiment presented herein, the BPF and LPF are located external to the RF tuner circuit 271 which is implemented as a single chip. This is not critical as they may also be implemented internal to the RF tuner circuit. As described supra, the image reject filter functionality is implemented by the combination of the BPF and LPF filters. In operation, the FPA is operative to receive the IF signal from the previous mixer stage (FIG. 5). Aliasing, generated by previous mixing stage, is removed from the amplified signal via the combination of BPF 288 and LPF 290. Buffer 278 functions to combine (or concatenate) the filter responses of the two filter stages.

The matching circuit functions to match impedance and signal levels from the filtering stages to the input of the ADC in the PHY. Digital filtering is used to implement the channel select functionality normally performed by the SAW filter in prior art circuits. The digital filter in the PHY may comprise any suitable digital filtering technique, e.g., IIR, FIR, etc. and is not critical to the invention.

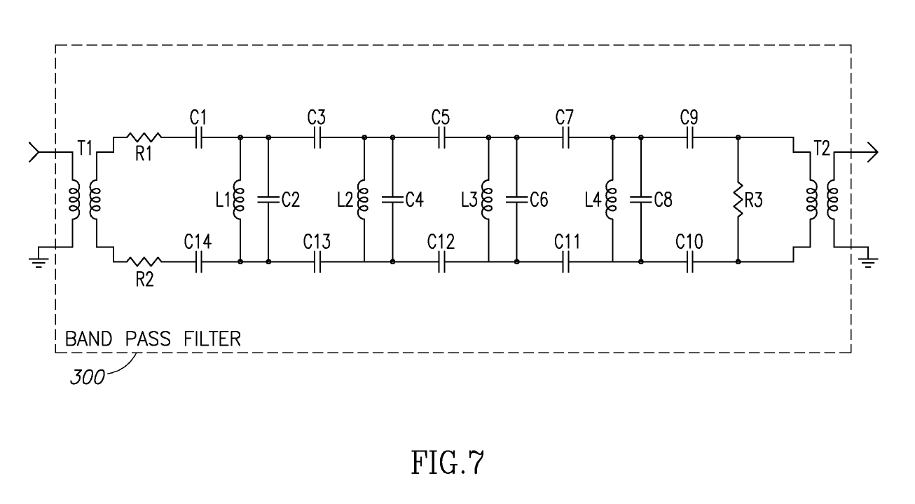

A schematic diagram illustrating an example implementation of the band pass filter portion of the analog image reject filter of the present invention is shown in FIG. 7. The band pass filter, generally referenced 300, comprises input signal transformer T1 operative to receive the signal output of the FGA 272 (FIG. 6), output signal transformer T2 operative to output the filtered signal to buffer 278, resisters R1, R2, R3, capacitors C1, C2, C3, C4, C5, C6, C7, C8, C9, C10, C11, C12, C13, C14 and inductors L1, L2, L3, L4.

The component values used in the example band pass filter shown in FIG. 7 is presented in Table 1 below.

TABLE 1
Band Pass Filter Component Values

| Component | | |
|---|---|---|
| Reference | Value | |
| C1 | 68 | pF |
| C2 | 33 | pF |
| C3 | 22 | pF |
| C4 | 33 | pF |
| C5 | 22 | pF |
| C6 | 33 | pF |
| C7 | 27 | pF |
| C8 | 33 | pF |
| C9 | 56 | pF |
| C10 | 56 | pF |
| C11 | 27 | pF |
| C12 | 22 | pF |
| C13 | 22 | pF |
| C14 | 68 | pF |
| L1 | 220 | nH |
| L2 | 220 | nH |
| L3 | 220 | nH |
| L4 | 220 | nH |
| R1 | 100 | ohm |
| R2 | 100 | ohm |
| R3 | 200 | ohm |

In operation, the band pass filter circuit implements a 4^{th} order (i.e. 4-stage) differential elliptic filter. Note that it is not intended that the invention be limited to the filter configuration or specific values presented shown herein, as other filter configurations can be used with the present invention.

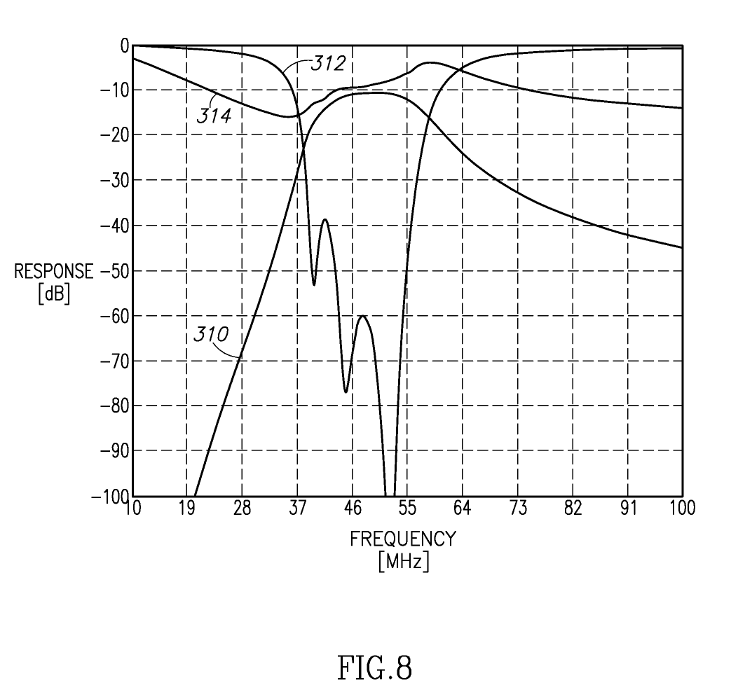

A graph illustrating the frequency response and return loss of the band pass filter of FIG. 7 is shown in FIG. 8. The S21 frequency response of the band pass filter is shown in trace 310. The center frequency of the filter is approximately 49.5 MHz. The insertion loss (i.e. return loss) of the input is shown in trace 312. The insertion loss from the output is shown in trace 314.

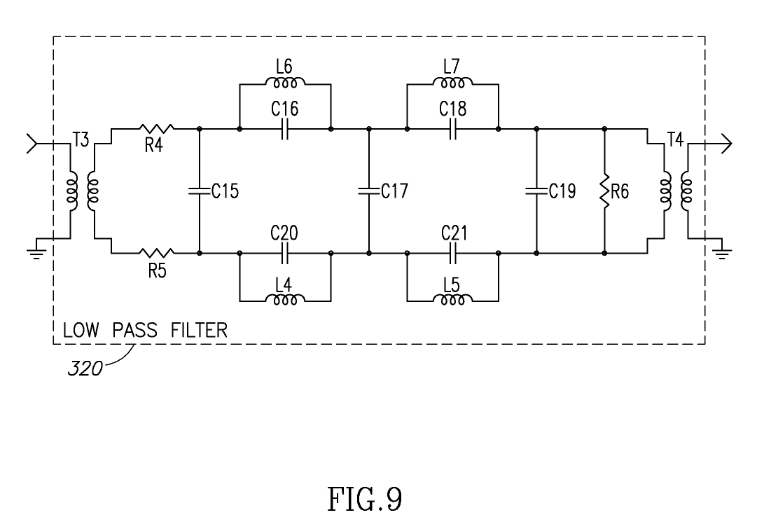

A schematic diagram illustrating an example implementation of the low pass filter portion of the analog image reject filter of the present invention is shown in FIG. 9. The low pas filter, generally referenced 320, comprises input signal transformer T3 operative to be coupled to the output of the buffer 278 (FIG. 6), output signal transformer T4 operative to be coupled to the matching circuit 280, resisters R4, R5, R6, capacitors C15, C16, C17, C18, C19, C20, C21 and inductors L5, L6, L7, L8.

The component values used in the example band pass filter shown in FIG. 7 is presented in Table 2 below.

TABLE 2
Low Pass Filter Component Values

| Component | | |
|---|---|---|
| Reference | Value | |
| C15 | 10 | pF |
| C16 | 15 | pF |
| C17 | 18 | pF |
| C18 | 10 | pF |
| C19 | 12 | pF |
| C20 | 15 | pF |
| C21 | 10 | pF |
| L5 | 220 | nH |
| L6 | 220 | nH |
| L7 | 220 | nH |
| L8 | 220 | nH |
| R1 | 100 | ohm |
| R2 | 100 | ohm |
| R3 | 200 | ohm |

In operation, the low pass filter circuit implements a 2^{nd} order (i.e. 2-stage) differential elliptic low pass filter. Note that it is not intended that the invention be limited to the filter configuration or specific values presented shown herein, as other filter configurations can be used with the present invention.

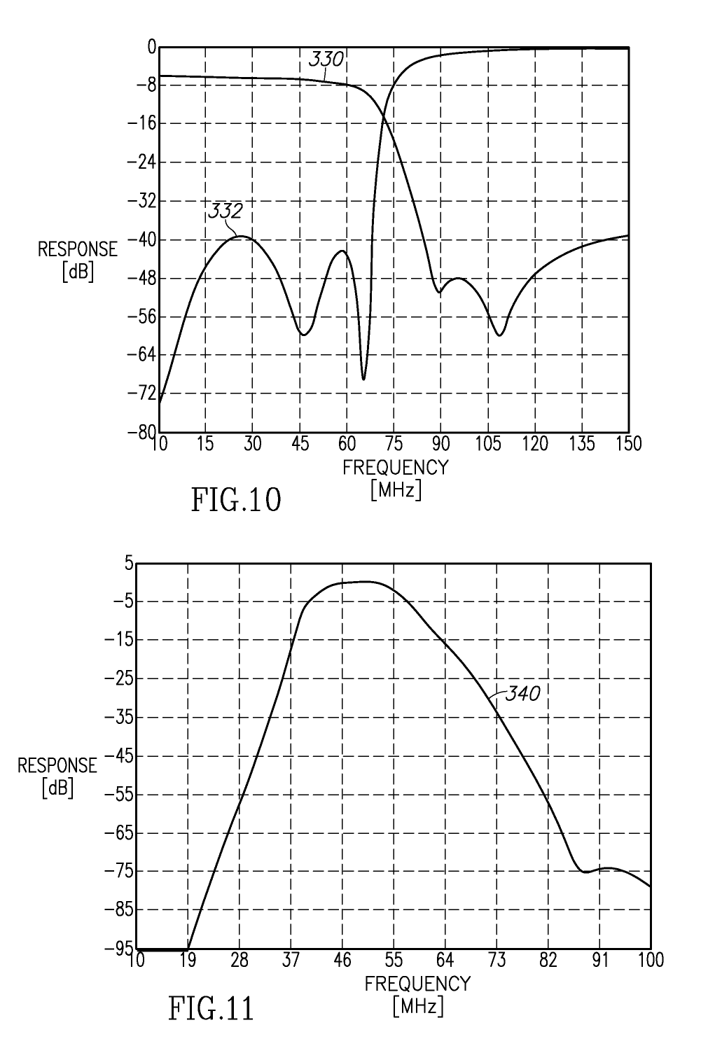

A graph illustrating the frequency response and return loss of the low pass filter of FIG. 7 is shown in FIG. 10. The frequency response of the low pass filter is shown in trace 330 with a cutoff frequency of approximately 50 MHz. The insertion loss is shown in trace 332.

A graph illustrating the overall frequency response of the combined band pass and low pass filters making up the image reject filter is shown in FIG. 11. The overall frequency response of the combination of BPF and LPS filters is shown in trace 340. The filter response has a center frequency of approximately 49.5 MHz. The rejection at 24.5 MHz is approximately 71 dB while the rejection at 86.5 MHz is approximately 71 dB as well.

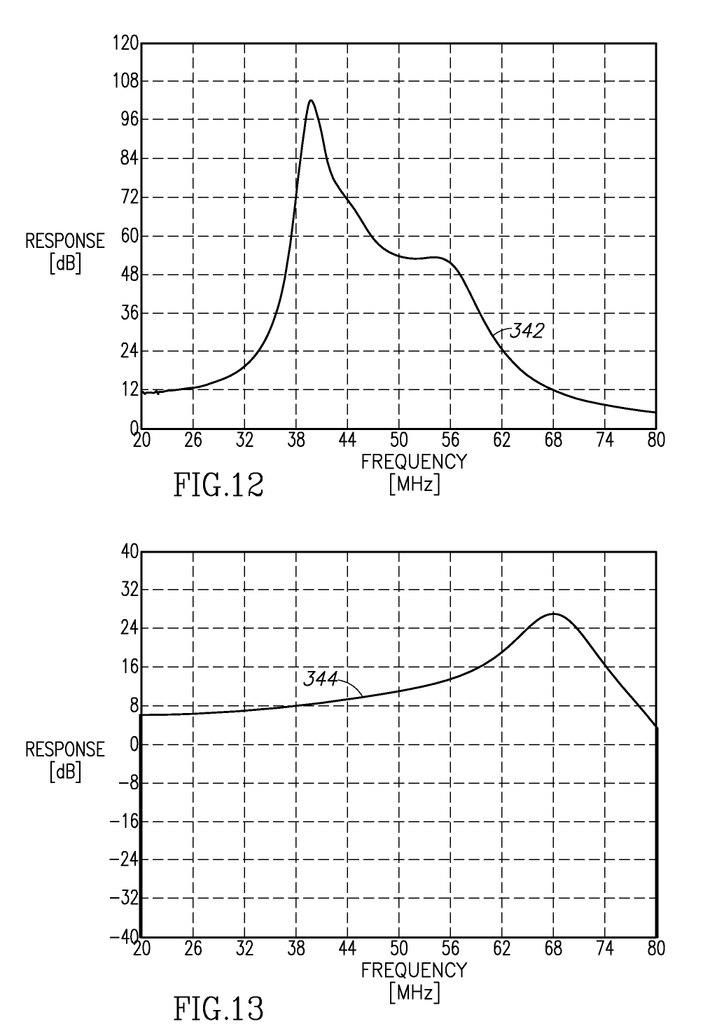

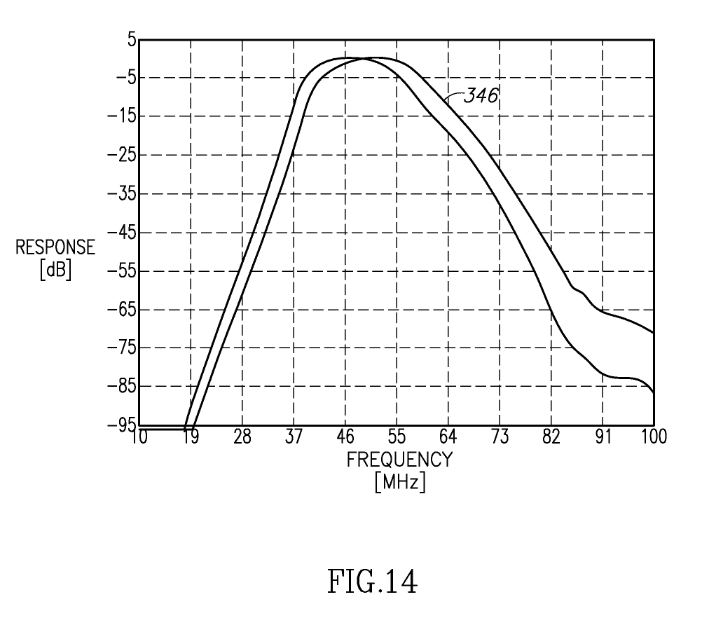

A graph illustrating the group delay of the band pass filter portion of the image reject filter is shown in FIG. 12 in trace 342. A graph illustrating the group delay of the low pass filter portion of the image reject filter is shown in FIG. 13 in trace 344. A graph illustrating a Monte Carlo analysis of a simulation of the image reject filter including both band pass and low pass filters is shown in FIG. 14. Note that the ripple within a 7 MHz band (46-53 MHz) is less than 1.5 dB peak to peak. Ripple within an 8 MHz band (45.5-53.5 MHz) is less than 2.5 dB peak to peak. Attenuation at 24.5 MHz is greater than 55 dB and attenuation at 86.5 MHz is also greater than 55 dB.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A surface acoustic wave (SAW) replacement circuit, comprising:
an image reject filter operative to remove aliasing from a multi-channel signal input thereto; and
a digital filter operative to output selected one or more channels from the output of said image reject filter.

2. The circuit according to claim 1, wherein said input signal comprises a Data Over Cable Service Interface Specification (DOCSIS) signal.

3. The circuit according to claim 1, wherein said image reject filter is sufficient to meet Data Over Cable Service Interface Specification (DOCSIS) 2.0 requirements.

4. The circuit according to claim 1, wherein said image reject filter comprises
a band pass filter (BPF) coupled to said multi-channel input signal;
a radio frequency (RF) buffer operative to buffer the output of said band pass filter;
a low pass filter (LPF) coupled to the output of said RF buffer; and
wherein said RF buffer effectively combines the effects of said band pass filter and said low pass filter to effectively eliminate aliasing from said multi-channel input signal.

5. The circuit according to claim 4, wherein said RF buffer comprises a variable gain amplifier (VGA).

6. The circuit according to claim 1, wherein said digital filter is implemented in a PHY circuit and is operative to eliminate unwanted adjacent channels from a filtered signal output of said image reject filter and to generate one of a plurality of channels in accordance with a corresponding tune command.

7. The circuit according to claim 1, wherein said image reject filter comprises a plurality of filters wherein the frequency response of each filter is combined to generate a desired overall filter response.

8. An image reject filter for use in a cable modem, comprising:
a band pass filter coupled to an intermediate frequency (IF) signal input and having a first filter response;
a buffer coupled to the output of said band pass filter;
a low pass filter coupled to the output of said buffer and having a second filter response, said low pass filter operative to generate a filtered output signal therefrom; and
wherein said first filter response combined with said second filter response yields a combined response operative to remove aliasing in said IF input signal produced during one or more previous mixing stages.

9. The image reject filter according to claim 8, wherein said buffer comprises an amplifier.

10. The image reject filter according to claim 8, wherein said combined response is operative to meet Data Over Cable Service Interface Specification (DOCSIS) requirements.

11. The image reject filter according to claim 8, wherein said band pass filter is constructed using one or more relatively low Q multilayer inductors.

12. The image reject filter according to claim 8, wherein said low pass filter is constructed using one or more low Q multilayer inductors.

13. A receive signal path for use in a Data Over Cable Service Interface Specification (DOCSIS) compatible cable modem, comprising:
a tuner integrated circuit (IC) operative to generate an intermediate frequency (IF) signal output in accordance with an RF input signal and a channel reference signal;
an image reject filter coupled to said IF signal output and operative to remove aliasing therefrom and to generate a filtered IF signal thereby; and
a PHY circuit comprising a digital channel selection filter coupled to said filtered IF signal and operative to output one of a plurality of channels in accordance with a corresponding tune command.

14. The receive signal path according to claim 13, wherein said tuner IC comprises:
a channel reference signal generated from a frequency reference input in accordance with a tune command signal;
a radio frequency (RF) receive signal input adapted to receive a DOCSIS RF input signal; and
a mixer operative to mix said RF input signal with said channel reference signal to yield said IF signal thereby.

15. The receive signal path according to claim 13, wherein said image reject filter comprises an off-chip series combination band pass filter and low pass filter.

16. The receive signal path according to claim 15, further comprising an amplifier buffer placed between said band pass filter and said low pass filter.

17. The receive signal path according to claim 15, wherein the combined response of said band pass filter and low pass filter sufficient to meet Data Over Cable Service Interface Specification (DOCSIS) requirements.

18. The receive signal path according to claim 13, wherein said image reject filter comprises a plurality of filters separated by radio frequency (RF) buffers wherein the frequency response of each filter is combined to generate a desired overall filter response.

19. A cable modem, comprising:
a memory;
one or more interface ports;
a single chip tuner integrated circuit (IC), said tuner IC comprising:
a frequency reference input;
means for generating a channel reference signal from said frequency reference input in accordance with a tune command signal;
a CATV radio frequency (RF) receive signal input;
a tuner circuit operative to mix said RF receive signal with said channel reference signal to yield an intermediate frequency (IF) signal thereby;
an off-chip image reject filter coupled to said IF signal and operative to remove aliasing therefrom and to generate a filtered IF signal thereby;
a PHY circuit coupled to said tuner, said PHY circuit comprising a digital channel selection filter coupled to said filtered IF signal and operative to output one of a plurality of raw video channel streams in accordance with a corresponding tune command; and
a processor coupled to said memory, said one or more interface ports, said tuner and said PHY circuit, said processor operative to implement a media access control (MAC) layer operative to generate one or more output video streams from said plurality of raw video streams input thereto.

20. The cable modem according to claim 19, wherein said plurality of channels comprises Data Over Cable Service Interface Specification (DOCSIS) channels.

21. The cable modem according to claim 19, wherein said image reject filter comprises an off-chip series combination band pass filter and low pass filter.

22. The cable modem according to claim 21, further comprising an amplifier buffer inserted between said band pass filter and said low pass filter.

23. The cable modem according to claim 21, wherein the combined response of said band pass filter and low pass filter sufficient to meet Data Over Cable Service Interface Specification (DOCSIS) requirements.

24. The cable modem according to claim 21, wherein said band pass filter is constructed using one or more relatively low Q multilayer inductors.

25. The cable modem according to claim 21, wherein said low pass filter is constructed using one or more low Q multilayer inductors.

26. The cable modem according to claim 21, wherein said image reject filter comprises a plurality of filters separated by radio frequency (RF) buffers wherein the frequency response of each filter is combined to generate a desired overall filter response.
